(19) United States
(12) Patent Application Publication
(10) Pub. No.: US 2015/0001166 A1
(43) Pub. Date: Jan. 1, 2015

(54) SUBMERSIBLE FILTER SYSTEM

(71) Applicant: AMIAD WATER SYSTEMS LTD., D.N. Upper Galil 1 (IL)

(72) Inventors: Ra'anan Ben-Horin, D.N. Jordan Valley (IL); Shahar Nuriel, Yesud HaMa'ala (IL); Omry Levin, Shimshit (IL); Yuval Shamir, D.N. Upper Gallilee (IL); Ud Mussel, D.N. Lower Galilee (IL)

(73) Assignee: AMIAD WATER SYSTEMS LTD., D.N. Upper Galil 1 (IL)

(21) Appl. No.: 14/373,408

(22) PCT Filed: Jan. 21, 2013
(86) PCT No.: PCT/IL2013/050059

§ 371 Date: Jul. 21, 2014

Related U.S. Application Data
(60) Provisional application No. 61/589,371, filed on Jan. 22, 2012.

(51) Int. Cl. B01D 29/15; C02F 1/00; B01D 29/52; B01D 29/64; B01D 29/66

(52) U.S. Cl. CPC B01D 29/15; B01D 29/6438; B01D 29/66; B01D 29/52; C02F 1/001; C02F 2103/007
USPC 210/791; 210/409; 210/411; 210/332; 210/767

(57) ABSTRACT

Provided is a filter system including an exposed filtration media. The filter system further includes a raw liquid inlet flow path into a filtering side of the filtration media, a filtered liquid outlet flow path at a filtered side of the filtration media extending to a filtered liquid collecting port, a liquid pump for propelling liquid through the filtration media, and a rinsing mechanism for removing filtrate from the filtering side of the filtration media.

### TECHNOLOGICAL FIELD

This invention relates to submersible filter systems of the type configured for submersing in a liquid and filtering said liquid.

### BACKGROUND

Filtration systems used for filtering raw liquids from reservoirs such as sea, pond, lake, etc. are typically positioned external to the reservoir, for example, offshore or on a raft. However, under these circumstances, treating large volumes of liquid requires transfer of the raw liquid to the filtration systems and use of offshore platforms.

Alternatively, positioning the filtration systems within deep water reservoirs such as at the seabed would require the filtration systems to be housed in shells adapted to withstand high atmospheric pressures for long periods of time, leading to high production and maintenance costs of the filtration systems.

Thus, there is a need for filtration systems configured to filter raw liquids when substantially submerged and to eliminate the high maintenance and servicing costs.

### GENERAL DESCRIPTION

According to the present disclosed subject matter there is provided a submersible filter system for submerging within a liquid, wherein said filter system is configured for filtrating the liquid and further wherein the filter system is configured with a cleaning/rinsing arrangement.

The filter according to the disclosed subject matter comprises an exposed filtration media, a raw liquid inlet flow path into a filtering side of the filtration media, a filtered liquid outlet flow path at a filtered side of the filtration media extending to a filtered liquid collecting port, a liquid pump for propelling liquid through the filtration media, and a rinsing mechanism for removing filtrate from the filtering side of the filtration media.

The term ‘filtering side’ of the filtration media denotes a face of the filtration media which is exposed to and in direct flow communication with the raw liquid, and the term ‘filtered side’ of the filtration media denotes a face of the filtration media which is in flow communication with the filtered liquid.

The filtering side of the filtration media is exposed to the raw liquid, i.e. extending in free/direct flow communication with the raw liquid in which the filter system is immersed.

Any one of more of the following features and designs can be incorporated in a filter according to the present disclosed subject matter, independently or in combination with one or more features or designs:
The filtration media can be any one or combination of liquid filtration media, i.e. disc filters, thread filters, solid filters, screen filters, etc. According to a particular design the filtration media is in the form of a cylindrical cartridge;
Filtration through the filtration media can take place in a radially inwards or in a radially outwards oriented direction;
The filter system is configured for submersing at any depth, i.e. suited for use at shallow water and at deep water, namely even thousands of meters below sea level.
A course screen can be configured at the raw liquid inlet flow path, to prevent egress of large particles into the system. A course screen can have a mesh with apertures greater than about 1mm;
Rinsing/cleaning of the filtration media can take place simultaneously while the filter system is a filtering liquid;
Rinsing liquid for a rinsing/cleaning process can be obtained directly from the filter system during a filtration process, or from an accumulator accumulating a portion of the filtered liquid, or from an external source of liquid, e.g. a fresh liquid supply or filtered liquid from a neighboring filtering system;
A filtered liquid accumulator extends between the outlet flow path and the rinsing mechanism, said filtered liquid accumulator being a flexible container;
Filtrate and waste rinsing liquid are washed to the environment liquid in which the filter system is immersed, and wherein natural or artificial currents carry them away from the vicinity of the filter system;
Liquid flow into the raw liquid inlet flow path is facilitated through flow of the raw liquid, e.g. when the filter system is submerged in a river and the like, or by a liquid propelling mechanism, a liquid propelling mechanism can be any sort of mechanical pump or a liquid motion inducing mechanism, e.g. a gas bubbles generator, flow current generator etc.;
Rinsing/cleaning the filtration media can take place by either or both of liquid jets applied to the filtering side of the filtration media, and suction applied to the surfaces of the filtration media. According to particular examples, suction is applied to the filtration face of the filtration media and rinsing jets can be applied to either or both the filtering face and the filtration face of the filtration media;
The cleaning mechanism is configured with a cleaning pump for propelling a rinsing liquid through the filtration media in direction from the filtered side to the filtering side thereof.
A single pump can be used as the liquid pump and the cleaning pump, wherein suitable valve arrangements are required. Alternatively the liquid pump and the cleaning pump are separate pumps;
The rinsing liquid or vacuum applied over respective surfaces of the filtering side and filtered side, is applied through nozzles mounted on arms configured for at least one of rotary and linear motion, wherein at least said linear motion is reciprocal.
Rotary and linear motion of the cleaning mechanism are imparted by a motion unit. The motion unit can be an electric motor, a hydraulic motor, piston, and the like, with appropriate gear mechanism applies when necessary;
The filter system can comprise an array of filter units having their filtered liquid collecting port coupled to a common collecting manifold, with one or more liquid pumps for propelling liquid one or more of filtration media;
Each filter system of an array of filter units can be configured with an independent rinsing mechanism associated with an independent motion unit;
In a filter system comprising an array of filter units, one or more such filter units can operate in a filtering mode while one or more other such filter units operate in a cleaning mode
The filtration media is exposed to and in direct flow with the raw liquid in which it is to be submersed, and the filter system is devoid of a housing sealingly isolating the filtration media from the environment (i.e. the raw liquid).

### BRIEF DESCRIPTION OF THE DRAWINGS

In order to understand the disclosed subject matter and to see how it may be carried out in practice, embodiments will now be described, by way of non-limiting examples only, with reference to the accompanying drawings, in which:

FIG. 1A is a schematic illustration of a filter system in accordance with a first example of the present disclosed subject matter, configured with a screen-type filtration media and wherein filtration takes place radially outwardly, the system illustrated at a filtration mode;

FIG. 1B is a cross-section along line I-I in FIG. 1A;

FIG. 1C illustrates the filter system of FIG. 1A at a rinsing mode;

FIG. 2A illustrates a filter system in accordance with a different example, configured with a screen-type filtration media and wherein filtration takes place radially inwardly, the system illustrated at a filtration mode;

FIG. 2B illustrates the system of 2A at a rinsing mode;

FIG. 3A illustrates a different configuration of a filter system configured with a mesh-type filtration media, with filtration taking place radially inwardly, said system further comprising a rinsing liquid reservoir, the system illustrated at its filtration mode;

FIG. 3B illustrates the system of FIG. 3A in a rinsing mode;

FIG. 4A illustrates a filter system similar to that disclosed in FIG. 3A, however devoid of a rinsing liquid accumulator, the system illustrated at its filtration mode;

FIG. 4B illustrates the system of FIG. 4A at the rinsing mode;

FIG. 5A illustrates a cross-flow type filter system configured with a mesh-type filtration media, the system further configured with a rinsing liquid reservoir, the system illustrated at a filtration mode;

FIG. 5B is a cross-section along V-V in FIG. 5A;

FIG. 5C illustrates the filter system of FIG. 5A in a rinsing mode;

FIG. 6A is directed to a configuration of the present disclosed subject matter wherein the filter system comprises an array of disk-type filtration medias and further configured with a rinsing liquid reservoir, the system illustrated at its filtration mode;

FIG. 6B illustrates the system of FIG. 6A at the rinsing mode;

FIG. 7A is a modification of the configuration illustrated in connection with FIG. 6A, each filter unit configured with control valve and the system devoid of a rinsing liquid reservoir and illustrated at its filtration mode;

FIG. 7B illustrates the filter system of FIG. 7A at the rinsing mode;

FIG. 8A illustrates a modification of the configurations illustrated in FIGS. 6 and 7, wherein the filter system comprises several clusters of disk-type filtration medias and a rinsing liquid reservoir, the system illustrated in its filtration mode;

FIG. 8B illustrates the system of FIG. 8B in its rinsing mode;

FIG. 9A illustrates a filter system in accordance with yet an example of the present disclosed subject matter configured with a thread-type filtration media and a rinsing liquid reservoir, the system illustrated at its filtration mode;

FIG. 9B illustrates the filter system of FIG. 9A at its rinsing mode;

FIG. 10A illustrates a filter system configured with a plurality of filtering units each configured with a thread-type filtration media, the system further comprising a rinsing liquid reservoir and the system being illustrated in its filtration mode;

FIG. 10B illustrates the system of FIG. 10A at its rinsing mode;

FIG. 11A illustrates a filter system similar to that disclosed in connection with FIG. 10A however wherein the rinsing mechanism extends within each of the filtering units, the system illustrated at a filtration mode;

FIG. 11B illustrates the filter system of FIG. 11A at a rinsing mode;

FIG. 12A illustrates a cross-flow filter system wherein liquid is propelled through the plurality of filter units by a bubble generator, the system illustrated at its filtration mode;

FIG. 12B illustrates the filter system of FIG. 12A in a rinsing mode;

FIG. 13A illustrates a filter assembly composed of clusters of filter systems of the type disclosed in FIG. 12A, the system illustrated at its filtration mode; and

FIG. 13B illustrates the filter system of FIG. 13A at its rinsing mode.

### DETAILED DESCRIPTION OF EMBODIMENTS

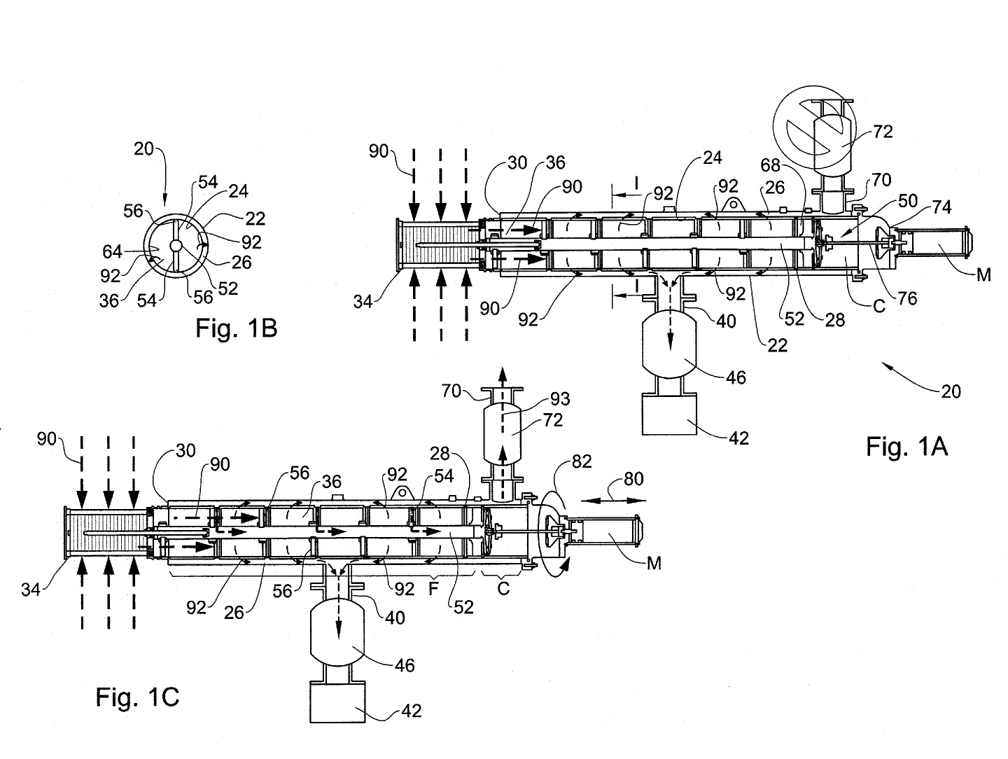

Attention is first directed to FIGS. 1A-1C illustrating a filter system in accordance with a first example of the present disclosed subject matter generally designated 20 and designed as a submersible filtration system, i.e. suitable for submersing within a liquid, at any desired depth, and further wherein said liquid is to be filtered by the filter system 20 (i.e. serves as the raw liquid).

In the following description, the examples illustrated in FIGS. 1 to 5 are configured with a mesh type (screen-type) filtration media.

The filter system 20 comprises a cylindrical housing 22 coaxially accommodating a mesh type (screen-type) filtration media 24 defining therebetween an annular space 26 serving as a filtered liquid collecting port.

In the following description, the examples illustrated in FIGS. 1 to 5 are configured with a mesh type (screen-type) filtration media.

The filtration screen 24 is secured and retained at its respective ends, within the housing 22, by two sealing rings at 28 and 30. A raw liquid inlet flow path extends through a rough screening grid 34 (configured for filtering large objects and dirt from entering the filter system and further to prevent marine life from entering thereto, the screen having a grid with apertures larger than about 1 mm), the raw liquid inlet flow path extending into an inside space 36 of the filter 24 wherein the space 36 is in fact in free liquid flow communication with the environment (raw liquid) in which the filter system is submerged.

The filtration liquid outlet flow path 26 extends into a filtration liquid collecting port designated 40 for conveying filtered liquid to a consumer designated 42, with a liquid pump 46 extending along said collecting port for propelling liquid from the internal space 36, through the filtration media 24, into the filtered liquid space 26 and then out towards the downstream consumer at 42.

Received within the space 36 there is a cleaning system generally designated 50 configured with a coaxially positioned nozzle carrying tube 52, fitted with a plurality of suction tubes 54, said suction tubes 54 radially extending and each fitted at a free end thereof with a suction nozzle 56 extending in close proximity to the inside surface, namely filtering side 64 of the filtration media 24.

The hollow tube 52 extends through an end plate 68 dividing the casing 22 into a filtration zone designated F (FIG. 1C) and a cleaning mechanism chamber designated C. The cleaning chamber C is configured with an outlet port 70 with a cleaning pump 72 fitted thereon.

The cleaning mechanism 50 further comprises a motor M (e.g. an electric motor, hydraulic motor, etc.) with a gear mechanism 74 articulated to a shaft 76 which in turn is articulated to the hollow tube 52, wherein the gear 74 is configured for imparting the shaft 76 reciprocal linear motion (arrowed line 80 in FIG. 1C) and rotary motion (reciprocal or not, as illustrated by arrowed line 82 in FIG. 1C).The hollow tube 52 sealingly projects through an opening in the wall 68 and extends into the cleaning space C.

In a filtration process (FIG. 1A) raw liquid represented by dashed arrows designated 90 enters through the course grid 34, along the raw liquid inlet flow path and into the central space 36 whereupon operation of the liquid pump 46 the raw liquid is forced through the filtration screen 24 into the filtered liquid outlet flowpath, namely the annular space 26 and from there the filtered liquid designated by fine arrows designated 92 flows through the filtered liquid collecting port 40 towards the consumer 42.

A rinsing/cleaning process (FIG. 1C) takes place however whilst the filtration process is active, wherein a portion of the filtered liquid 92 entering into the annular space 26 now serves for the rinsing process. In the rinsing process the motor M is activated, giving rise to combined linear reciprocal motion of the hollow tube 52 along with rotational motion thereof, and simultaneously the cleaning pump 72 is activated, causing a vacuum within the cleaning chamber C, resulting in suction force through the nozzles 56 whereby as they progress along the filtering side 64 of the screening filtration media 24 they suck any filtrate residing thereon, sucking it into the cleaning chamber C. The rinsing liquid together with the removed filtrate and dirt, represented by doted arrows and designated 93 (FIG. 1C), then flows into the outlet port 70 and out directly to the liquid ambient environment in which the filter is submersed, where the filtrate and dirt are carried away by currents and turbulent. A rinsing process ends upon halting the operation of the cleaning pump 72 and the motor M.

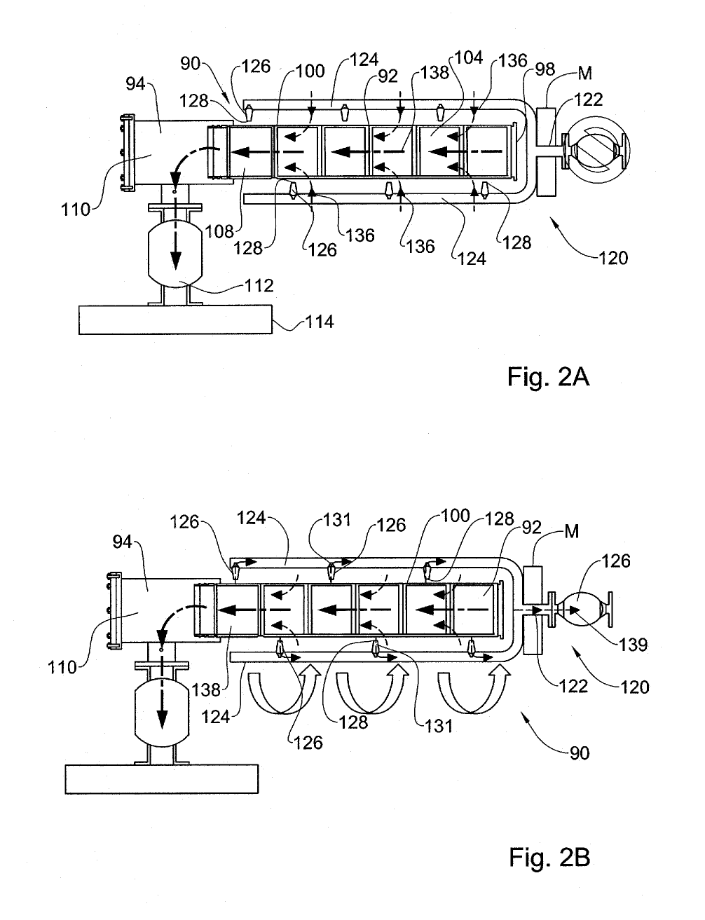

Further attention is now directed to FIGS. 2A and 2B of the drawings illustrated to a different example of a filter system in accordance with the present disclosed subject matter and generally designated 90. In the example of FIGS. 2A and 2B the filter system 90 comprises a cylindrical filter unit comprising a screen-type filtration media 92 secured at an end thereof by a rigid support structure 94), wherein the filtration media is completely exposed to the environment, namely to the raw liquid in which the filter system is submersed, such that when the filter system is submersed within a liquid, it is in full and direct contact therewith. The filtration media 92 is sealed by a sealing plate 98 at its fore end with the external surface thereof, namely filtering side 100 exposed to the raw liquid. A raw liquid inlet flow path extends through the grid of the filtration media 92 into a filtered liquid outlet flow path 108, extending within the tubular filter unit 92, and into a filtered liquid collecting port 110 which is in flow communication with a liquid pump 112 generating liquid flow through the filtration media 92, into the filtered liquid collecting port and out to the consumer 114.

The filtration media 92 is exposed within the raw liquid within which the filter system is submersed, the system being devoid of any housing.

A rinsing mechanism generally designated 120 is disposed external of the filter unit, the rinsing mechanism 120 comprises a central suction tubular axle 122 articulated to a drive and motion unit designated M for imparting same with rotary motion and at least reciprocal linear motion, about the longitudinal axis of the tube 122. The tube 122 is articulated to a cleaning pump 126, open to the environment, namely to the liquid in which the filter system is submersed. The opposite end of the tube 122 splits into a bifurcated arm arrangement comprising two arms designated 124, each fitted with a plurality of suction fingers 126 radially extending towards the external surface, namely the filtering side 100 of the filtration media 92, with suction nozzles 128 extending in close proximity to the external surface 92 of the filtration media 92.

It is however appreciated that reciprocal linear motion of the cleaning mechanism 120 can be avoided, however depending on the number of suction nozzles and their density along the external surface of the filtration media.

During a filtration process (FIG. 2A) raw liquid (designated by solid dashed lines 136) flow through the filtration media 92, owing to the propelling force imparted by the pump 112 wherein the filtered liquid (dash-dotted arrows designated 138) flow through the internal space into the filtered liquid collecting port 110 and out to the consumer at 114. During a filtering process, the cleaning pump 126 is halted.

A rinsing/cleaning process takes place simultaneously during a filtration process, and is illustrated in FIG. 2B. During a rinsing process, the cleaning pump 126 is activated, giving rise to suction force extending through the bifurcated arms 124 wherein the suction nozzles 128 traveling in close proximity over the external surface 100 (filtered side) of the filtration media 92 suck any filtrate, dirt, debris residing over the filtered side 100 and discards same to the open liquid wherein by turbulence is carried away.

The rinsing liquid together with the removed filtrate and dirt, represented by doted arrows and designated 139 (FIG. 2B), then flows through tube 122 and the pump 126 out directly to the liquid ambient environment in which the filter is submersed, where the filtrate and dirt are carried away.

In the examples of 3A and 3B there is illustrated a filter system generally designated 150 comprising a filtering unit, namely a filtration screen 152 extending substantially exposed within the raw liquid in which the filter system is immersed. The tubular filtration media 152 is secured by and extends into a support unit 154 configured with a filtered liquid chamber 158 with a filtered liquid outlet path extending from the inside space 160 within the filtration member 152, through the chamber 158, out towards a filtered liquid collecting port 162 from which it is propelled by a liquid pump 164 to a downstream consumer at 166.

A free end 170 of the tubular filtration media 152 is blocked by a plate 172 supporting a motor M articulated via appropriate gear transmission G to a hollow rinsing tube 176 which in turn is configured with a plurality of radially disposed rinsing arms 178, each configured at its free end with a rinsing nozzle 180 for emitting a liquid jet in close proximity to the filtering side 182 of the filtration media 152, wherein the motor M and gear transmission G are provided for imparting the rinsing tube 176 with reciprocal linear motion about its longitudinal axis as indicated by arrowed line 186 and rotary motion (reciprocally or not as indicated by arrowed line 188).

An opposite end of the rinsing tube 176 is articulated via coupling tube 190 to a rinsing booster 194 being in flow communication with a flexible rinsing liquid reservoir 198 which in turn is coupled via tube segment 200 and via pump 164 to the filtered liquid collecting port 162.

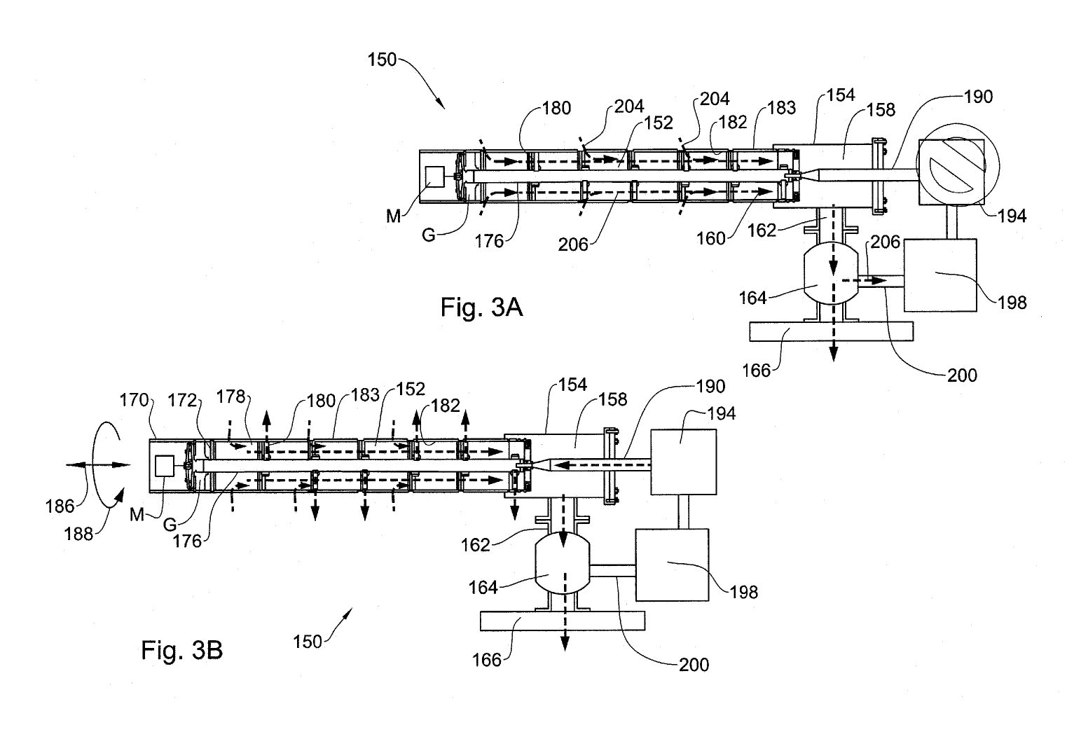

In a filtration mode of the filtering system 150 (FIG. 3A) raw liquid within the environment in which the filter system is submersed is forced to enter (owing to propelling motion of the liquid pump 164) through the filtration media 152 into the internal space 160, as represented by dashed arrows 204, wherein the filtered liquid (now designated by dot-dashed lines 206) flows about the filtered liquid outlet flow path into the chamber 158, through the port 162 and then out to the consumer 166. However, a portion of the filtered liquid is allowed to flow through tube section 200 into the flexible reservoir 198, wherein during a rinsing mode of the system, as illustrated in FIG. 3B, the booster 194 is activated simultaneously with the motor M giving rise to liquid jets emitted through the nozzles 180 towards the internal surface (filtering side) of the filtration media, whereby filtrates and dirt accumulated over the external face of the filtration media (filtering side) 183 is rinsed away into the raw liquid reservoir in which the filter system is immersed wherein it is drifted away. It is appreciated that during a filtration process the rinsing booster 194 as well as the motor M are arrested.

It is however appreciated that the rinsing process (FIG. 3B) takes place whilst the filtering process is still active. Further noted the liquid reservoir 198 is a flexible reservoir e.g. made of suitable rubber material and the like.

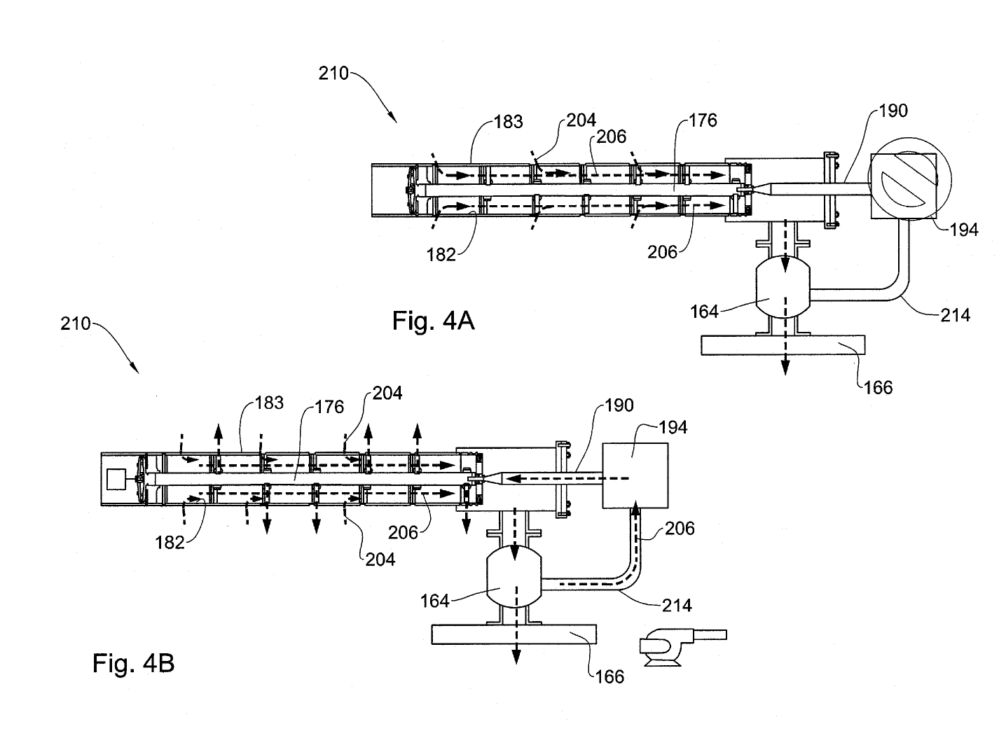

The filter system illustrated in FIGS. 4A and 4B and generally designated 210 is substantially similar to the filter system designated 150 and depicted in FIGS. 3A and 3B, however devoid of the flexible rinsing liquid reservoir 198. The system 210 is particularly suitable for use in considerable depth. For sake of clarification, like elements have been designated with like reference numbers.

In the filter system 210 of FIGS. 4A and 4B the pump 164 is directly connected to the cleaning pump/booster 194 by a connecting pipe section 214 and wherein the cleaning pump 194 is in turn connected with the rinsing tube 176 via the coupling tube 190.

The filtering mode takes place similarly to the disclosure made in connection with FIG. 3A above and reference is made thereto. However, at the rinsing mode (FIG. 4B) a portion of the filtered liquid (designated by dashed-dotted arrows designated 206) flows from the liquid pump 164 directly towards the cleaning pump 194 and then, via tube 190 into the cleaning tube 176 so as to generate rinsing jets of liquid against the inside surface 182 of the filtration media 183. It is noted that the filtration mode takes place simultaneously whilst filtration is ongoing.

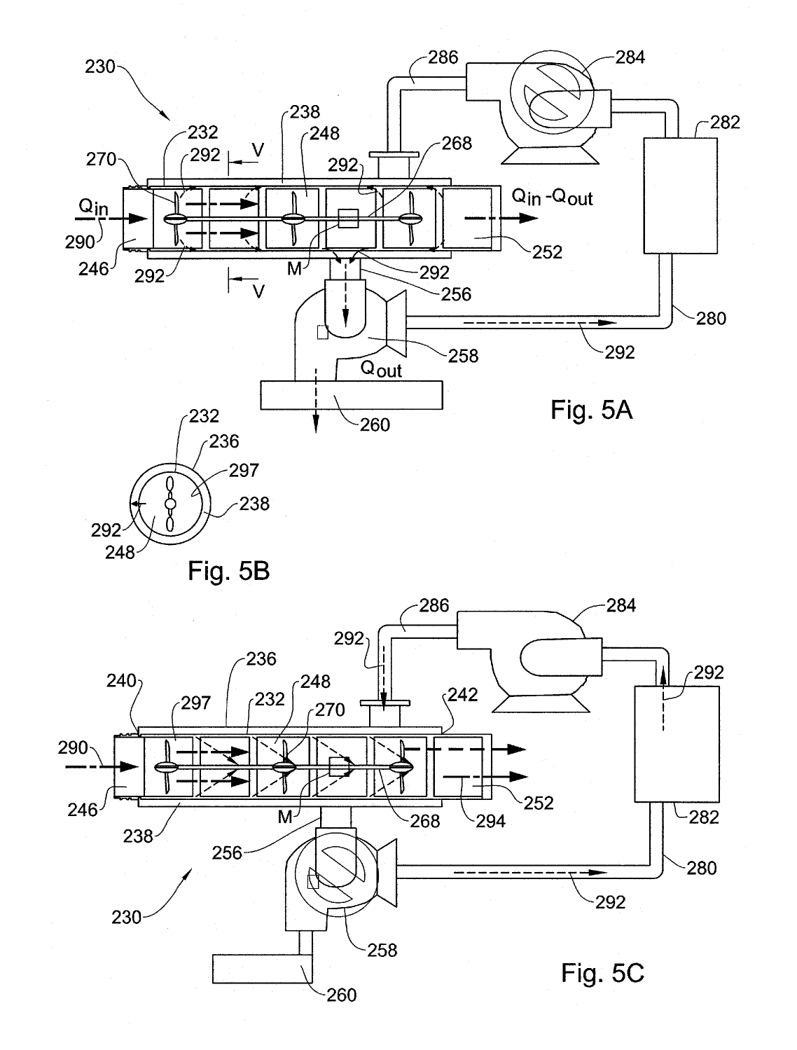

In the example depicted in FIGS. 5A-5C there is illustrated a filter system in accordance with yet an example of the present disclosed subject matter, generally designated 230, the system being a so-called cross flow filtration system, comprising a tubular filtration media 232 received within a sleeve 236 in a fashion defining between them a space 238, wherein the filtration media tube 232 is sealingly secured within the external sleeve 236 by sealing gaskets at 240 and 242.

A raw liquid inlet flow path 246 extends into the inner space 248 of the filtration media tube 232 and a filtered liquid outlet flow path 252 extends at an opposite, open end of the tubular filtration media 232. The filtration media 232 is a screen-type (fine mesh filter) with a liquid outlet port 252 extending at an opposite, open end of the tubular filter system. A filtered liquid collecting port 256 extends from the intermediate annular filtered liquid space to a liquid pump 258 and therefrom the liquid is transferred to a consumer 260.

The filtering system 230 is suitable for submersing within a source of flowing raw liquid, e.g. in a river, adjacent an outlet of a hydraulic station and the like, wherein the liquid is propelled through the tubular filter system. However, at low flow rates and insufficient liquid propelling force, a liquid propelling system is engaged so as to propel liquid at sufficient flow rate through the system. The propelling system comprises a central axis 268, coupled to a motor unit schematically represented at M wherein a plurality of impeller blades 270 are mounted on the axel 268 such that upon rotating the motor M the propeller blades rotate thereby propelling liquid through the space 248 at sufficient flow rate.

A rinsing mechanism of the filter system 230 comprises a bypass tube 280 extending from the liquid pump 258 into a flexible filtered liquid reservoir 282 which by means of a cleaning pump 284 and a connecting tube 286 is configured for propelling rinsing liquid into the annular space 238 as will be explained hereinbelow.

During a filtration mode of the system (FIG. 5A) raw liquid (designated by dashed arrows 290) is propelled along the raw liquid inlet flow path whereby upon activating the liquid pump 258 the raw liquid is forced to pass through the filtering screen of the filtration media 232 upon which the liquid is filtered. The filtered liquid, now represented by dash-dotted arrows designated 292 flows from the annular space 238, through the filtered liquid collecting port 256, via liquid pump 258 and out to the downstream consumer 260.

During a rinsing mode (FIG. 5C) the filtering process is not halted but rather, a portion of the filtered liquid which was accumulated within the flexible reservoir 282 during the filtration n process, is now propelled by cleaning pump 284, through tube 286 back into the annular space 238 whereby the liquid forced in a reverse direction removes filtrate from the inside surface 297 of the filtration media, where said filtrate (dotted arrow 294) flows out to directly to the open waters, i.e. the raw liquid reservoir in which the filter system is immersed.

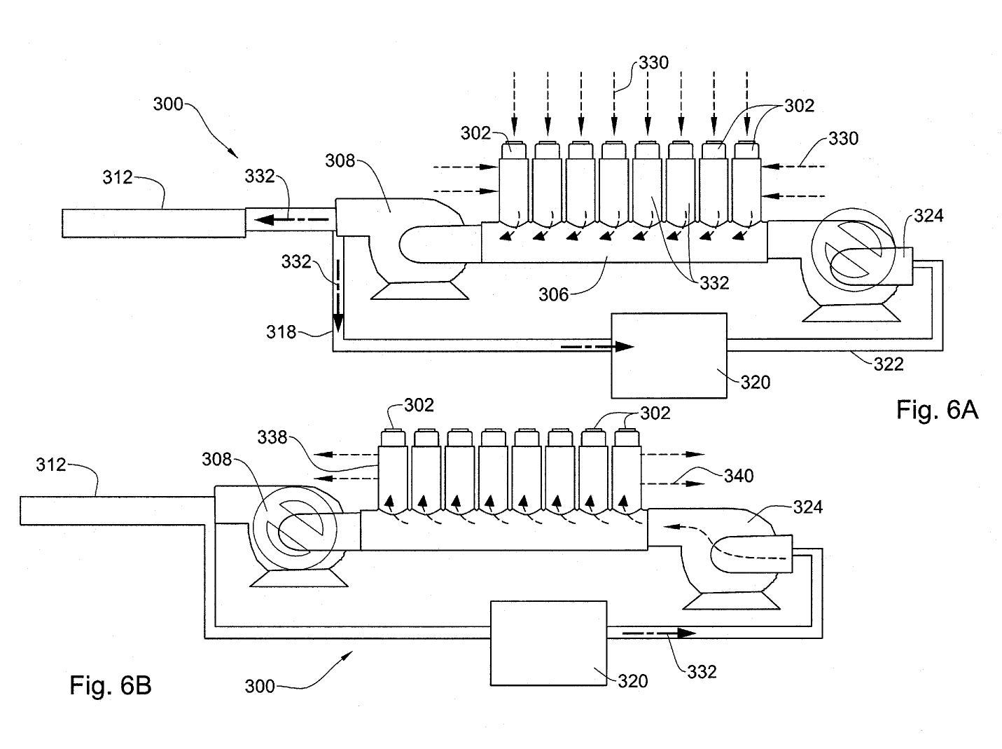

FIGS. 6 to 8 illustrate filters systems according to further examples of the present disclosed subject matter, wherein at these example the filtration media is a compact stack of filtration disks.

Turning now to the example illustrated in FIGS. 6A and 6B there is illustrated a filter system generally designated 300 and comprising a plurality of parallely disposed filter units 302, each filtering unit being a compact array of filtration disks, as known in the art. The interior space of each of the filter units 302 extends into a filtered liquid collecting port, namely collecting manifold 306, coupled to a liquid propelling pump 308 configured for propelling liquid from the environment i.e. from the raw liquid within which the filter system is submersed, through the filter unit 302 into the filtered liquid collecting port 306 and out to a consumer at 312. A portion of the filtered liquid flows through a connecting tube 318 towards a flexible filtered liquid reservoir 320 which is further coupled by tube section 322 to a cleaning pump 324.

The arrangement is such that during a filtration process of the system (FIG. 6A) raw liquid (designated by dashed arrows 330) is propelled through the filtration media (namely compacted filtration disks) owing to the suction generated by the liquid pump 302, wherein the liquid forced through the filtration disks is filtered and filtered liquid (now designated by dash-dotted arrows 332) now flows through the liquid pump 308 towards the downstream consumer 312, wherein a portion of the filtered liquid 332 flows into the filtered liquid reservoir 320, though during the filtration mode the cleaning pump 324 is halted.

Turning now to FIG. 6B, the filter system 300 is illustrated during a cleaning mode, wherein the liquid pump 308 is now halted whilst the cleaning pump 324 is activated, giving rise to filtered liquid, now serving as rinsing liquid 332 flowing from the reservoir 320 into the internal space of each of the filter units 302, thus flowing in a reverse direction and flushing away any filtrate which may have accumulated on the external surface 338 of the filter units 302, rinsed away by the rinsing liquid 340 into the raw liquid in which the liquid system is submersed.

Whilst in FIGS. 6A and 6B the filtration units 302 are illustrated in a position where they extend substantially parallel to one another and upright, it is appreciated that the filter units may extend radially from the central collecting hub manifold 306 thereby increasing the effective number of filtering units.

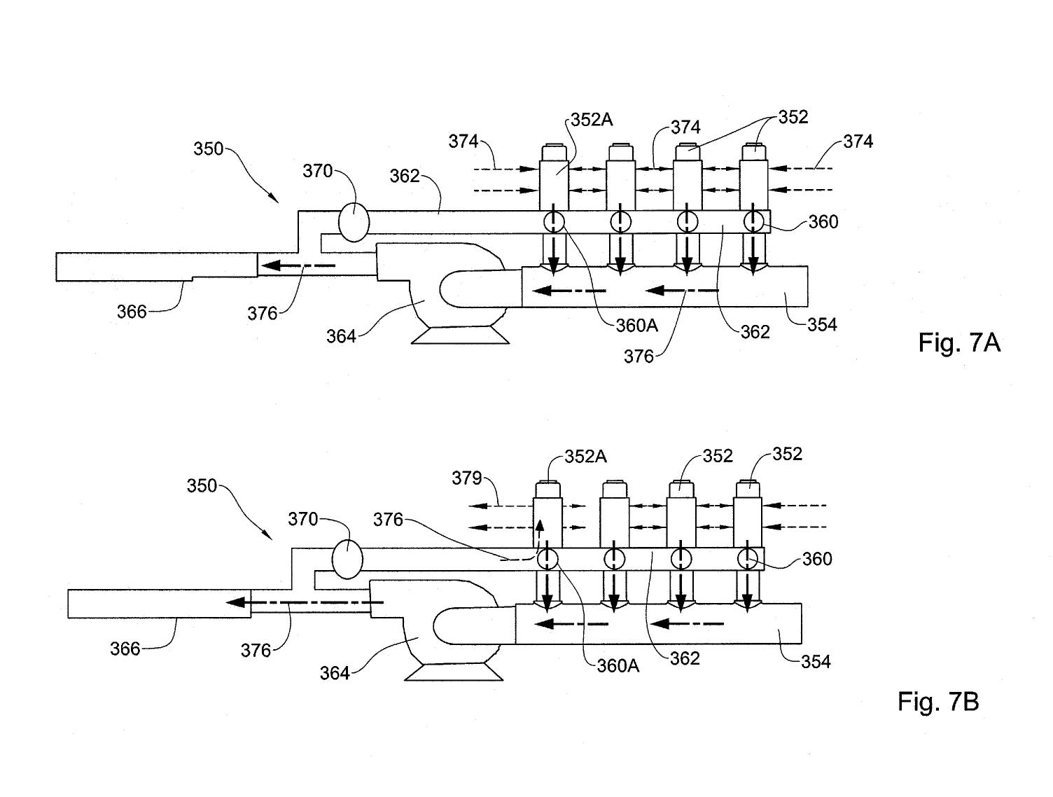

Turning now to FIGS. 7A and 7B there is illustrated yet another example of a filtering system in accordance with the present disclosed subject matter, generally designated 350. The filter system 350 resembles that illustrated in connection with FIGS. 6A and 6B and comprises a plurality of filter units 352 projecting radially upwardly (as an example only) from a filtered liquid collecting manifold 354, wherein each of the filter units 352 is a tower of compacted filtration disks. The interior space of each of the filter unit 352 is coupled via a three-way valve 360 to a rinsing line 362 and to the filtered liquid collecting pipe 354 the latter coupled to a liquid propelling pump 364 which in turn is coupled to a downstream consumer 366 with a branching off to the rinsing pipe 362 via a rinsing valve designated 370. It is however appreciated that rather than a three-way valve other valve arrangements can be used for liquid flow control, e.g. two tow-way valves, etc.

In a filtering mode (FIG. 7A) the liquid pump 364 is activated to draw raw liquid (dashed arrows designated 374) through the filtration media, namely the compacted filtration disks of each of the filter units 352, into the interior space of each filter unit 352 and then, through the respective three-way valves 360 into the filtered liquid collecting manifold 354, wherein filtered liquid is designated by a dashed-dotted arrow designated 376, which then flows through the liquid pump 364 downstream to the consumer at 366.

At a cleaning process of the filter unit 350 (designated in FIG. 7B) filtration continues simultaneously at one or more of the filtering units 352 whilst one or more other filter units 352 are switched into a rinsing mode. In the present illustrated example, the left filter unit designated 352A is switched into a rinsing mode by means of the respective three-way valve 360A now switched into a position where part of the filtered liquid (filtered by the other units active at their filtering modes) now serving as a rinsing liquid flows through the respective rinsed filter unit 352A, whereby the rinsing liquid is forced from the interior space of the filter unit outwardly thereby rinsing and 30 removing filtrate and other dirt (dotted arrows 379 in FIG. 7B) into the raw liquid environment in which the filter system is submersed, wherein the filtrate and dirt is washed away by turbulence.

It is however appreciated that in the configuration of FIGS. 7A and 7B the pressure generated by the liquid pump 364 should be slightly higher than the ambient liquid pressure within which the filter system is submersed, so as to facilitate rinsing of the filter units.

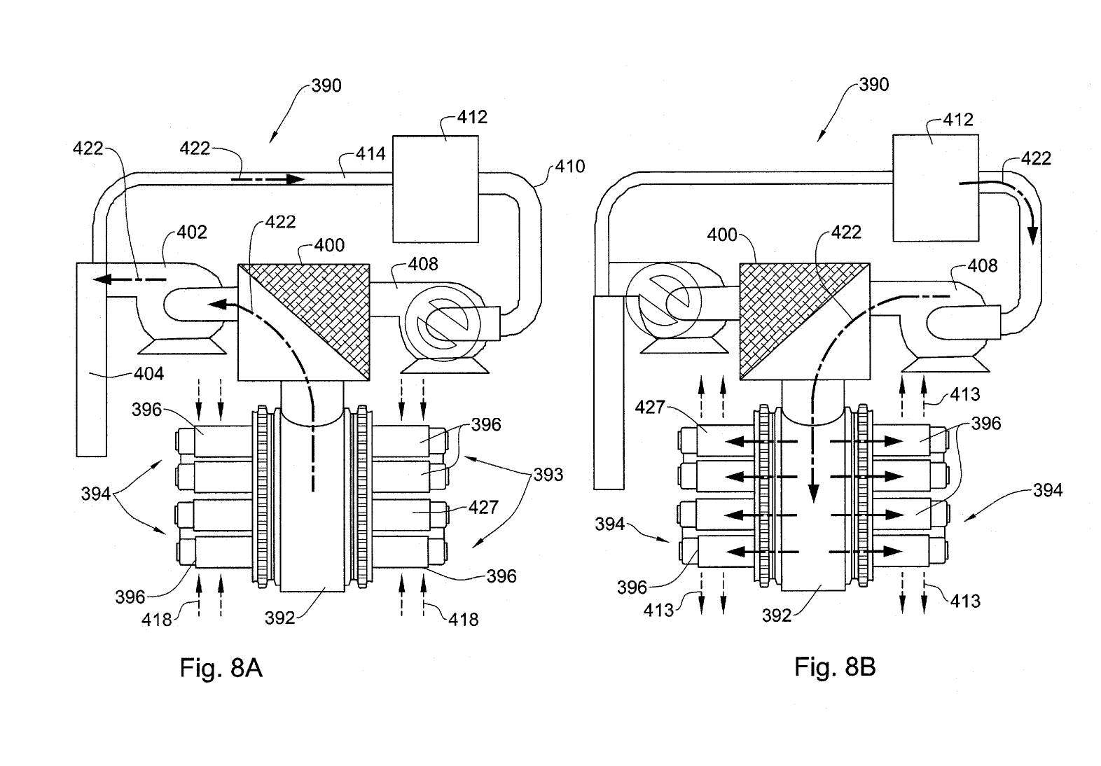

The configuration disclosed in FIGS. 8A and 8B is principally similar to that disclosed in connection with the previous example of FIGS. 7A and 7B, however wherein the filtering units are arranged in a different configuration, namely in clusters. In the example of FIG. 8B the filter system 390 comprises a central housing 392 from which laterally project in opposite directions, several clusters 394 of filter units, each with a unit designated 396. The filter units 396 are each a power of compacted filtration disks, configured for radially inwardly filtration, into an interior space of each filter unit which opens into a central filtered liquid collecting space within the housing 392, which in turn is coupled to a three-way control valve 400.

One port of the control valve 400 is coupled to a liquid propelling pump 402 having an outlet port extending towards a consumer downstream at 404 and another port of the valve 400 is selectively coupled to a cleaning pump 408 which is connected via a tube section 410 to a flexible filtered liquid reservoir 412 coupled via a pipe section 414 downstream to said liquid pump 402.

In a filtering mode of the filter system 390 (FIG. 8A) the cleaning pump 408 is halted and the valve 400 is opened so as to facilitate liquid flow from the common filtered liquid collecting space of the housing 392 with the pump 402. Upon activating the liquid pump 402, raw liquid (represented by dashed arrows 418, from the liquid environment within which the filter system is submersed) is forced through the filtration media (filtering disks in the present case) and then into the interior space of each filter unit 396 collected into the central filtered liquid collecting space and then, filtered liquid (designated by dash-dotted arrow 422 flows down stream to the consumer 404, with a portion of the filtered liquid flowing into the flexible filtered liquid reservoir 412. It is appreciated that at this position the cleaning pump 408 is halted.

Turning now to the cleaning mode illustrated in FIG. 8B, the process of which takes whilst filtration is stopped, whereby the three-way valve 400 is now converted so as to allow liquid flow only in direction from the cleaning pump 408 into the collecting space within the central housing 392 whereby filtered liquid within the reservoir 412 now serves as a rinsing liquid (dotted arrows 413) is propelled by means of the cleaning pump 408 and forced into the interior space of each of the filter units 396 and then out through the filtration disks rinsing away any filtrate and dirt accumulating on the external surface 427 of the filtration media, said filtrate and dirt being drifted and carried away by currents within the liquid in which the filter system is submersed.

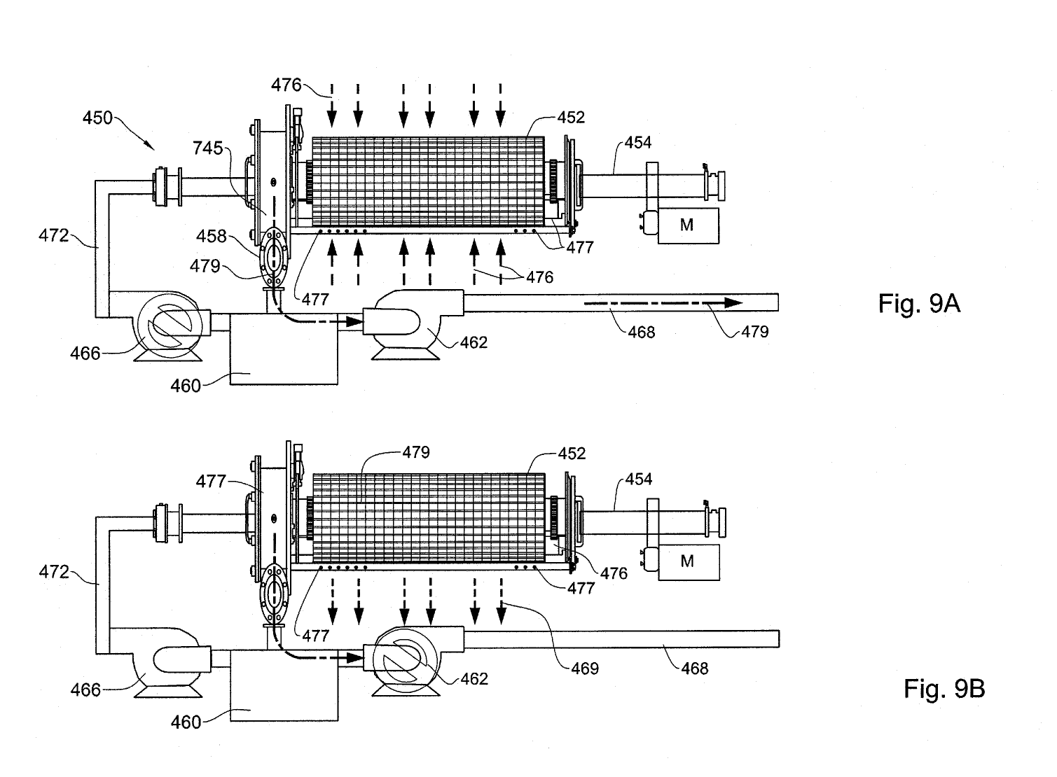

The examples illustrated from here on are directed to filter systems wherein the filtration media is a thread-type filter. With reference first being made to FIGS. 9A and 9B there is illustrated a filter system generally designated 450 comprising a filter unit 452 composed of a plurality of thread-type filter cassettes/segments configured into a plurality of filtration disks compacted about a longitudinal support axel 454, wherein each of the filtration segments has an opening into a central filtered liquid collecting path extending within the hollow tube of axel 454.

The filtration unit is revolvable together with the axel 454 by means of a motor designated M which may be an electric motor, an hydraulic motor and the like, configured for revolving the filter unit 452 about the longitudinal axis of the tube 454 during a rinsing process, as will become apparent hereinafter.

A filtered liquid outlet flow path extends from the collecting tube 454 into a filtered liquid collecting port at 458 which in turn extends into a flexible rinsing liquid reservoir 460, said reservoir being connected to a main liquid pump 462 at one side and to a cleaning pump 466 at another side, where the main pump 462 is connected for propelling filtered liquid to a downstream consumer designated 468. The cleaning pump 466 is in turn coupled via a pipe link 472 into the central collecting manifold 454 the purpose of which will become apparent hereinafter. The pipe segment 472 extends into a rinsing sprinkler divider 475 from extend several sprinkler arms 476 each fitted with a plurality of rinsing nozzles 477 extending in close proximity with the external surface 479 of the filtration segments.

During a filtration mode, as illustrated in FIG. 9A, the cleaning pump 466 is not active whilst the main liquid pump 462 is activated to propel liquid and generate a suction for raw liquid (represented by dashed lines 476) forced through the filtration media namely threaded filters 452 into the central filtered liquid collecting tube 454 whereby filtered liquid (represented by dash-dotted arrows designated 479) flows through the collecting port 458, through the flexible reservoir 460 and then via liquid pump 462 to the downstream consumer at 458. At the filtration mode, a portion of the filtered liquid accumulates at the flexible reservoir 460.

During a rinsing mode of the filter system 450, as depicted in FIG. 9B, the main liquid pump 462 is halted whilst the cleaning pump 466 is now activated to thereby propel filtered liquid from the rinsed liquid reservoir 460, through pipe segment 472 into the array of rinsing sprinklers at 477 wherein the plurality of jets immersed against the external surface of the filtering threads rinse filtrate and dirt accumulated thereto, said filtrate and dirt (represented by dotted arrows designated 477) being washed directly into the ambient liquid in which the filter system is submersed.

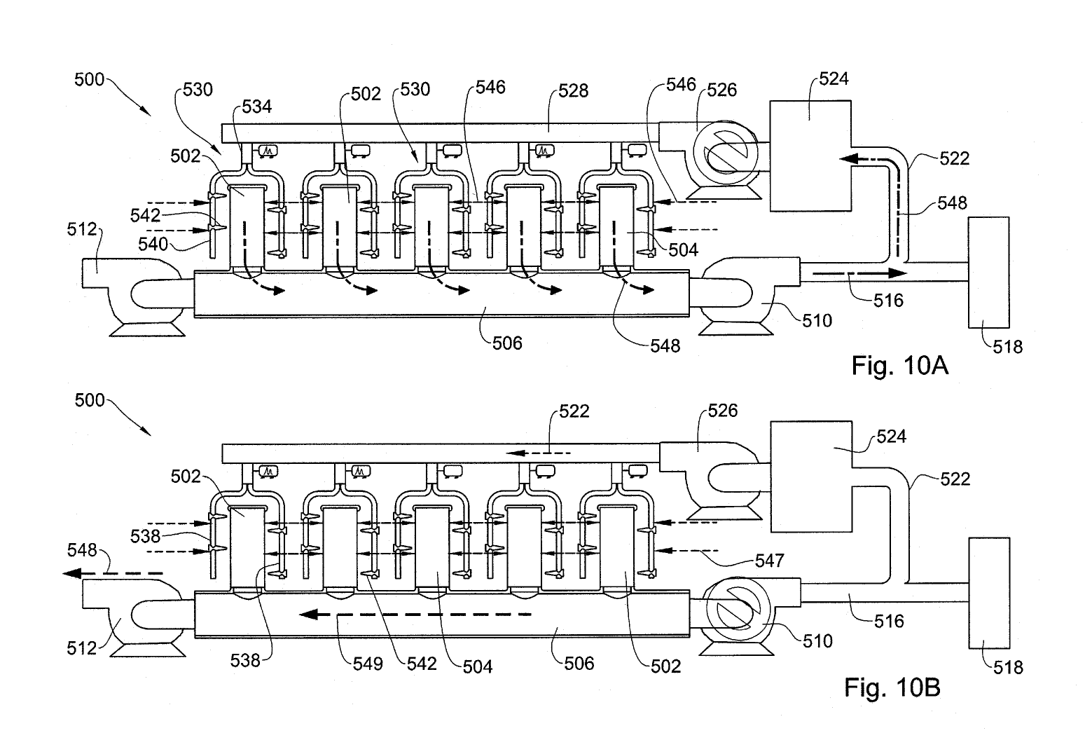

In the example of FIGS. 10A and 10B there is illustrated yet a modification of a filter system in accordance with the present disclosed subject matter, generally designated 500, wherein the system comprises a plurality of filter units 502, each configured as a coil of filtration threads, rather than filtration cassettes as disclosed in the previous example, though other forms of filtration media can be utilized as well.

Each of the filtration units is configured with an external filtration surface 504 and with an internal space (not seen) extending into a central filtered liquid collecting flow path within the liquid collecting manifold 506 which is connected at one end to a filtration pump 510 and at an opposite end to a flushing pump 512, the latter open to the ambient raw liquid within which the filter system 500 is submersed. Extending from the liquid pipe 510 there is an outlet port 516 extending to a downstream consumer 518, however with a branching off pipe line at 522 coupled to a flexible filtered liquid reservoir 524.

A cleaning pump 526 is configured for pumping liquid from the filtered liquid reservoir 524 into a rinsing liquid manifold 528 from which extend a plurality of rinsing mechanisms generally designated 530, each configured with a central pipe 534 coupled to a motion generating unit designated M configured for imparting the pipe 534 with at least a rotary motion though reciprocal linear motion may be applied as well. The pipes 534 extend into bifurcated rinsing arms 538 parallely extending with rinsing rods 540 extending therefrom in a substantially radial direction with rinsing nozzles 542 at their ends, said rinsing nozzles extending in close proximity to the external surface 504 of each of the filtration units 502. It is noted that rinsing mechanism can comprise one or more rinsing arms, rather than a bifurcated arrangement as illustrated in the drawings.

In the filtration mode, as illustrated in FIG. 10A the flushing pump 512 and the cleaning pipe 526 are halted, whilst the main liquid pump 510 is activated so as to propel liquid through the system. The raw liquid from the ambient is forced to enter the filter units 502, said raw liquid represented by dashed arrows designated 546 whereby as the raw liquid flow is forced through the filter units 502 it is filtered, whereby the filtered liquid (represented by dash-dotted arrows designated 548) flow into the central filtered liquid collecting manifold 506, and then through the pump 510 downstream to the consumer 518, with a portion of the filtered liquid 548 flowing also into the filtered liquid reservoir 524.

When it is now desired to rinse/clean the filter system 500, the main liquid pump 510 is halted whilst the flushing pump 512 and the cleaning pump 526 are activated whereby filtered liquid from the reservoir 524, now serving as a rinsing liquid flows through the manifold 528 into each of the cleaning mechanisms 530 thereby, upon rotating of the motors M the arms of the cleaning sprinklers rotate whilst emitting a cleaning jet against the external surface 504 of the filter units. As this takes place, part of the rinsing liquid with the filtrate and dirt residing on the external surface of the filter units is washed away to the ambient (arrows 547), whilst liquid entering into the interior space of each of the filter units 502 flows into the collecting manifold 506 and then is expelled to the ambient liquid by the flushing pump 512 (the rinsing liquid is represented by dotted arrows designated 549).

It is appreciated that reciprocal linear motion of the rinsing arms, namely sprinklers 538 may be omitted proving there is a sufficient number of rinsing jets applied over the filter units and depending on their density.

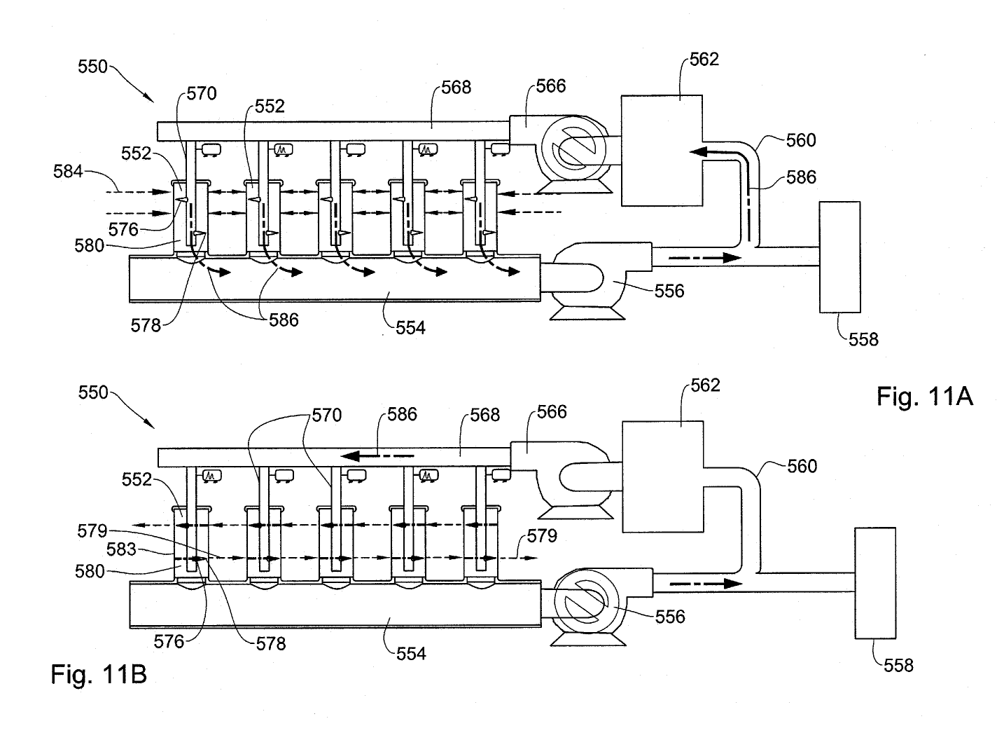

Turning now to FIGS. 11A and 11B there is illustrated a variation of the example disclosed in connection with FIGS. 10A and 10B wherein the filtration system 550 comprises a plurality of filter units 552 being coiled thread-type filter units, with an interior space of each one extending into a central filtered liquid collecting port, namely manifold 554 which in turn is coupled to a liquid pump 556 extending to a downstream consumer at 558 with a branching off pipe section 560 extending into a flexible filtered reservoir 562. Extending from the reservoir 562 there is a cleaning pipe 566 which in turn is coupled to a rinsing manifold 568 from which extend a plurality of rinsing sprinklers 570, each articulated with a rotary motor M and with a plurality of radially extending rinsing arms 576, each configured at its free end with a rinsing nozzle 578 extending in close proximity with an internal surface 580 of each of the filtration units 552.

During a filtration process, as depicted in FIG. 11A, the cleaning pump 566 is halted whilst the main liquid pump 556 is operated to thereby propel liquid through the system. Raw liquid, illustrated by dashed lines designated 584 is forced through the filtering threads of the filter units 552 into the central space of each filter unit and therefrom, the filtered liquid, now illustrated by dash-dotted arrows 586 flows into the central filtered liquid collecting manifold 554 from where it is propelled by pump 556 to the downstream consumer 558.

Turning now to FIG. 11B, when the filter system is converted into a cleaning mode, the main liquid pump 556 is halted whilst the cleaning pump 566 is operated to thereby propel liquid from the filtered liquid reservoir 562 into the manifold 568 wherefrom the liquid is diverted into each of the cleaning sprinklers 570 to thereby emit rinsing jets through the nozzles 578 against the inside surface 580 of each of the filter units 552, whereby any filtrate and dirt accumulating on either the internal surface 580 or the external surface 583, is washed away by the rinsing liquid represented by dotted arrows 579, into the ambient raw liquid within which the filter system is submersed.

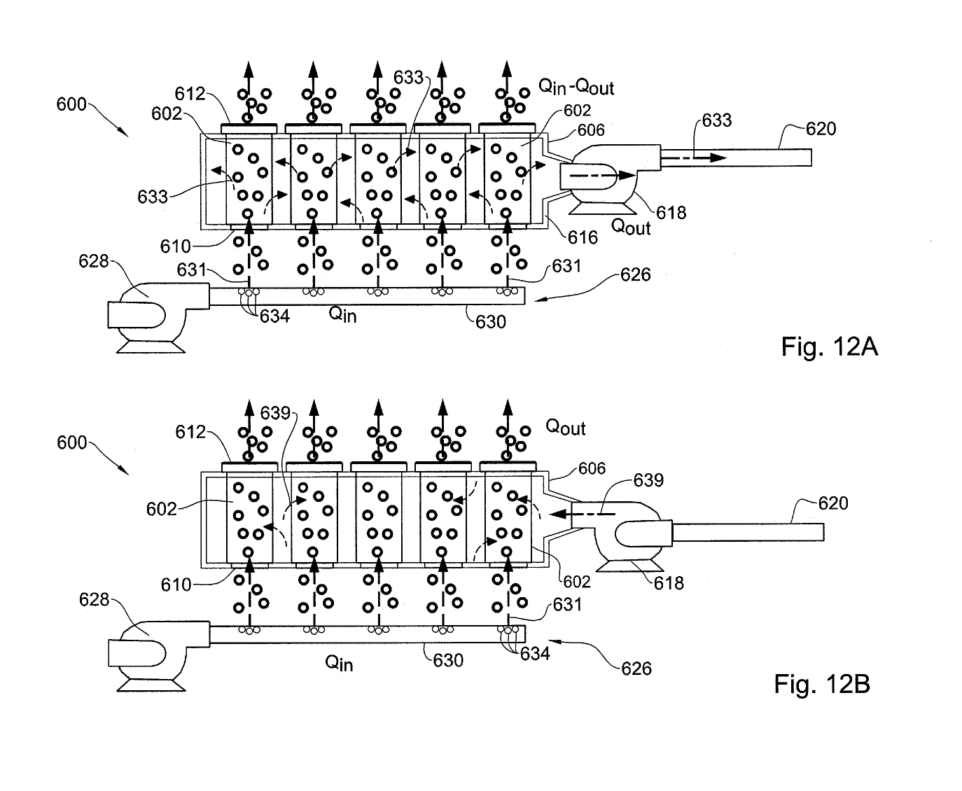

In FIGS. 12A and 12B there is illustrated a different concept of propelling liquid through a filter system in accordance with the present disclosed subject matter. The filter system generally designated 600 comprises a plurality of thread-type filter units 602 which in the present example are parallely disposed in an upright orientation and are all received within a collecting manifold 606 forming a liquid tight environment around the external surface of the filter units 602. However, the filter system is a cross-flow system wherein each filter unit 602 has at a bottom portion thereof a raw liquid inlet port 610 and a raw liquid outlet port 612 at a top thereof. Extending from the casing 606 there is a filtered liquid collecting port 616 extending to a liquid pump 618 which in turn is configured for propelling liquid to a downstream consumer 620.

Extending below the raw liquid inlet ports there is a liquid propelling generator generally designated 626 in the form of a bubble generator configured with a pump 628 coupled to a manifold 630 configured with a plurality of openings 634 extending below each of the raw liquid inlet ports such that upon activating the pump 628 liquid is turbulated giving rise to flow in an upwards direction along with generating bubbles directing flow in an upwards direction.

In the filtration mode of the system 600 (FIG. 12A) the liquid propelling mechanism 626 is activated by activating the pump 628 and likewise the pump 618 is activated. Raw liquid 631 flowing in a cross-flow manner through each of the open cylindrical filter units 602 is partially forced to filter through the thread filter media of each of the filter units, wherein the filtered liquid 633 collected within the filtered liquid collecting case 606 and then flows through the collecting port 616, via pump 618 downstream to the consumer 620.

In the rinsing mode of the filter system 600, as illustrated in FIG. 12B, the liquid pump 618 is operated in a reversed sense, in a back-flush manner whereby liquid 639 is forced through the cassette 606 and forced through the filtration media, namely the coiled thread, into the central space of each of the filter units, wherein the dirt is then washed away by the raw liquid flowing upwards owing to the continuous flow of raw liquid propelled by the liquid propelling mechanism 626, as discussed herein in connection with FIG. 12A.

It is appreciated that the propelling mechanism 626 requires an ongoing supply of gas for proper operation thereof.

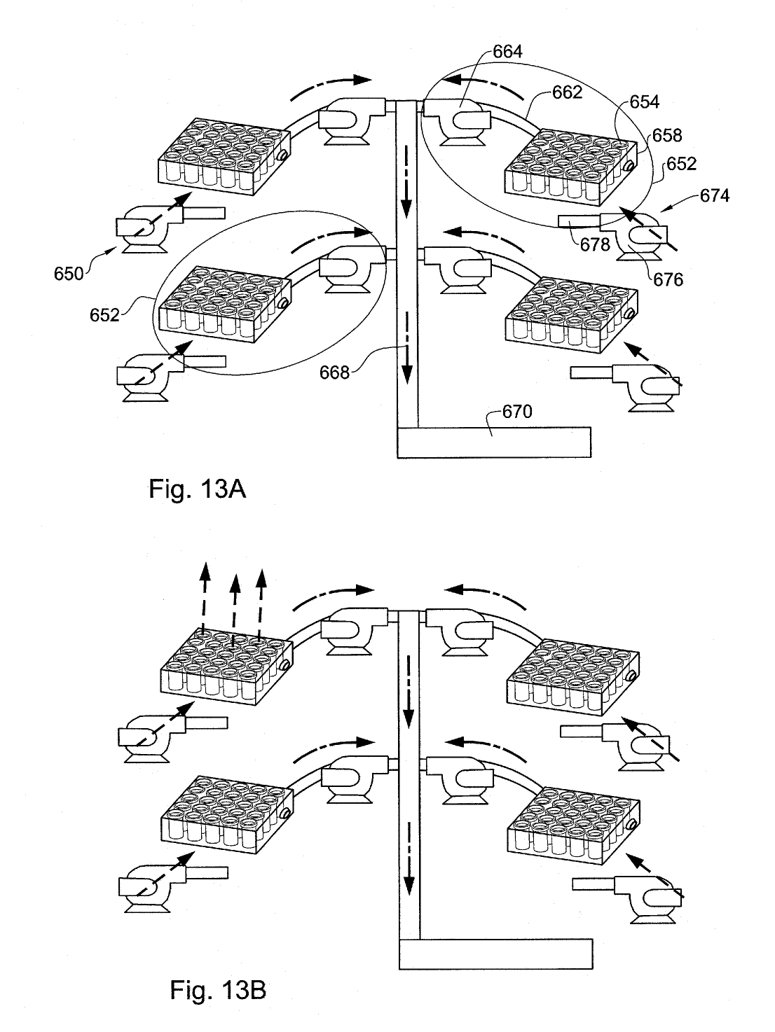

The example of FIGS. 13A and 13B is based on the concept in connection with FIGS. 12A and 12B, the system generally designated 650 and comprises a plurality of clusters 652 (four in the present example) each composed of several filtering clusters (four in the present example) wherein each such cluster 652 operates in the same fashion as discussed in connection with FIGS. 12A and 12B. Each filtration cluster 652 comprises a plurality of filter units 654 received within a sealed collecting case 658 from which extends a filtered liquid collecting pipe 662 coupled to a liquid pump 654 which in turn is coupled to a central collecting manifold pipe 668 connected to a downstream consumer 670.

Each of the filter clusters 652 is configured with a liquid propelling generator 674 configured with a bubble generating pump 676 and a distributing unit 678 for propelling liquid in an upwards direction through the cross-flow filter unit 654, as discussed hereinabove in connection with the example of FIGS. 12A and 12B.

An advantage of a system of the configuration disclosed in connection with FIGS. 13A and 13B is such that all filtration clusters can simultaneously operate in a filtration mode or, alternatively one or more filtration clusters may undergo rinsing/cleaning as discussed hereinabove whilst other clusters continue the filtration process as discussed hereinabove, wherein the a filtration cluster is rinsed using liquid simultaneously filtered by another cluster in the system.

1. A filter system, comprising:
at least a partially exposed filtration media;
a raw liquid inlet flow path into a filtering side of the filtration media;
a filtered liquid outlet flow path at a filtered side of the filtration media extending to at least one filtered liquid collecting port;
at least one liquid pump for propelling liquid through the filtration media; and
a rinsing mechanism for removing filtrate from the filtering side of the filtration media.

2. The filter system in accordance with claim 1, wherein the filter system is devoid of a housing sealingly isolating the filtration media from the environment, and wherein the filtration media is substantially exposed to the environment.

3. The filter system in accordance with claim 1, wherein the filtration media is exposed to and is configured for being in a direct flow with the raw liquid in which it is to be submersed.

4. The filter system in accordance with claim 1, wherein the filtration media is in the form of a cylindrical cartridge.

5. The filter system in accordance with claim 1, wherein the filtration media is a screen filter.

6. The filter system in accordance with claim 1, wherein the filtration media is any one or more combination of a disc filter, a thread filter, a solid filter, a screen filter and any combination thereof.

7. The filter system in accordance with claim 1, wherein filtration through the filtration media can take place in a radially inwards or in a radially outwards oriented direction.

8. The filter system in accordance with claim 1, wherein filter system is configured for submersion at any depth.

9. The filter system in accordance with claim 1, wherein filter system further comprises a course screen configured at the raw liquid inlet flow path.

10. The filter system in accordance with claim 1, wherein the rinsing mechanism is configured for rinsing simultaneously while the filter system is filtering the raw liquid.

11. The filter system in accordance with claim 1, wherein the rinsing liquid is obtained from the filter system during a filtration process.

12. The filter system in accordance with claim 1, wherein the filter system further comprises a filtered liquid accumulator configured for accumulating a portion of the filtered liquid, and wherein the rinsing liquid is obtained from the accumulator.

13. The filter system in accordance with claim 1, wherein the filter system further comprises a filtered liquid accumulator configured to extend between the outlet flow path and the rinsing mechanism, said filtered liquid accumulator being a flexible container.

14. The filter system in accordance with claim 1, wherein the rinsing mechanism is configured with a cleaning pump for propelling a rinsing liquid through the filtration media in direction from a filtered side to a filtering side thereof.

15. The filter system in accordance with claim 1, wherein the liquid pump is further configured for propelling a rinsing liquid and wherein the pump is fitted with a valve arrangement.

16. The filter system in accordance with claim 1, wherein the filter system comprises an array of filter units, each filter unit having at least partially exposed filtration media and a filtered liquid collecting port coupled to a common collecting manifold, and wherein the filter system further comprises one or more liquid pumps for propelling liquid from and/or to the filtration media.

17. The filter system in accordance with claim 1, wherein the filter system comprises an array of filter units, wherein each filter unit of the array of filter units is configured with an independent rinsing mechanism associated with an independent motion unit.

18. A method for filtering liquid, comprising:
filtering said liquid through a filtration system submerged in the liquid, said system comprising
at least partially exposed filtration media,
a raw liquid inlet flow path into a filtering side of the filtration media,
a filtered liquid outlet flow path at a filtered side of the filtration media extending to at least one filtered liquid collecting port,
at least one liquid pump for propelling liquid through the filtration media, and
a rinsing mechanism for removing filtrate from the filtering side of the filtration media.

19. The method in accordance with claim 18, further comprising rinsing filtration media by propelling a rinsing liquid through the filtration media in a direction from a filtered side to a filtering side thereof.

20. The method in accordance with claim 18, further comprising rinsing the filtration media by propelling a rinsing liquid through the filtration media in a direction from a filtered side to a filtering side thereof, and wherein the rinsing liquid is obtained from the filter system during a filtration process.
